(19) United States
(12) Patent Application Publication
(10) Pub. No.: US 2025/0135609 A1
(43) Pub. Date: May 1, 2025

(54) LIGHTED SOCKET WRENCH

(71) Applicant: Michael Kolavo, Hammond, IN (US)

(72) Inventor: Michael Kolavo, Hammond, IN (US)

(21) Appl. No.: 18/927,772

(22) Filed: Oct. 25, 2024

Related U.S. Application Data
(60) Provisional application No. 63/594,244, filed on Oct. 30, 2023.

(51) Int. Cl. B25B 13/46; B25B 13/06; B25B 23/00; B25B 23/18

(52) U.S. Cl. CPC B25B 13/463; B25B 13/06; B25B 23/0035; B25B 23/18

(57) ABSTRACT

A lighted socket wrench having a ratchet body, a ratchet drive member and a lighted socket. The ratchet body houses a power supply connected to wiring that terminates at a pair of leads disposed in a head recess of the ratchet body. The head recess retains the ratchet drive member, the ratchet drive member carrying a pair of proximal electrical contacts that are ring-shaped (such as washer contacts) so as to remain in contact with the ratchet body leads as the ratchet drive member rotates in the head recess. A pair of distal electrical contacts of the ratchet drive member touch a pair of contacts of the lighted socket when the lighted socket is connected to the ratchet drive member, so that current is delivered from the power supply through the ratchet drive member contacts to the lighted socket to illuminate a light source connected to the lighted socket.

### CROSS-REFERENCE

This application claims the priority benefit of U.S. Provisional Patent Application No. 63/594,244, filed Oct. 30, 2023, entitled LIGHTED SOCKET WRENCH, which is hereby incorporated herein for all purposes in its entirety.

### FIELD OF THE DISCLOSURE

The present disclosure relates to a lighted socket wrench. More particularly, it relates to a socket wrench including a light source disposed at the fastener receiving end of a socket.

### SUMMARY

According to an aspect of the disclosure, a lighted socket wrench comprises a ratchet body, a power supply, a ratchet drive member, a lighted socket, and a power circuit. The power supply is housed in the ratchet body. The ratchet drive member is rotatably connected to the ratchet body for rotation about a drive axis. The lighted socket comprises a socket body and a light source connected to the socket body. The light source is adapted to be energized by electric current, and when so energized, to emit light. The lighted socket is adapted to be removably connected to the ratchet drive member. The power circuit is adapted and configured to deliver electric current from the power supply to the light source to energize the light source when the lighted socket is connected to the ratchet drive member.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is an exploded left side elevation view of a lighted socket wrench according to an embodiment.

FIG. 2A is a front/distal side elevation view of a ratchet body of the lighted socket wrench of FIG. 1.

FIG. 2B is a front/distal side elevation view of the ratchet body as shown in FIG. 2A, enlarged and truncated to illustrate details of a ratchet body head region.

FIG. 3 is a top-right-rear/proximal perspective view of a ratchet drive member of the lighted socket wrench of FIG. 1.

FIG. 4 is a top-right-front/distal perspective view of a lighted socket of the lighted socket wrench of FIG. 1.

FIG. 5 is a rear/proximal perspective view of the lighted socket of FIG. 4.

FIG. 6 is top-right-front/distal perspective view of a protective socket sheath for the socket shown in FIGS. 4 and 5 of the lighted socket wrench shown in FIG. 1.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed lighted socket wrench, reference is made to the accompanying drawings, which form a part hereof, and in which are shown by way of illustration various examples of the disclosed subject matter. Other specific arrangements of parts, example devices, systems, and environments, can be used, and structural modifications and functional modifications can be made without departing from the scope of the disclosed subject matter.

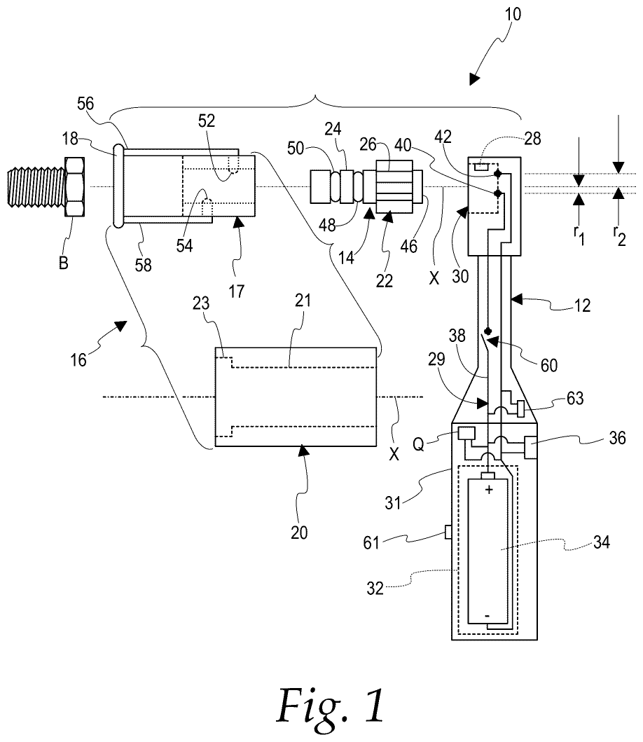

Turning to FIG. 1, there is shown an exploded left-side elevation view of a lighted ratcheting socket wrench 10 according to an embodiment of the disclosure. The wrench 10 includes a ratchet body 12, a rachet drive member 14, and a detachable lighted socket 16 assembled to one another in series along a longitudinal ratchet drive axis X. More particularly, the ratchet body 12 has a left-facing front side and a right-facing rear side as shown in FIG. 1, the rachet drive member 14 having a proximal rear side and a distal front side, its rear side being adapted to connect to the front side of the ratchet body 12 The socket 16 has a proximal rear side and a distal front side, its rear side being adapted to connect to the ratchet drive member 14, its front side having a cavity adapted to mate with a corresponding fastener, such as a hex nut or bolt head inserted into the cavity, so that rotating the socket 16 about the ratchet drive axis X drives like rotation of the fastener.

The socket 16 includes a socket body 17 and an electric light source 18, the light source 18 being connected to the socket body 17 so as to be disposed at or near a distal end of the socket body 17. “Connected” will be understood in this regard to include, without limitation, a light source being glued, force-fit, removably magnetically mounted, mechanically fastened, housed, clipped, enclosed, or molded to a socket body (such as by molding a protective sheath around both the socket body and the light source in such a manner as to retain each in a fixed position relative to the sheath), so that the light source is held in a fixed position relative to the socket body. In the case of the light source 18 being magnetically mounted, the socket body 17 can be magnetic or can include a permanent magnet, and the light source 18 can include a ferromagnetic material that is magnetically attracted to the socket body. The ferromagnetic material of the light source 18 can comprise or be separate from electrical contacts (not shown) disposed on a rear face of the light source 18, which are adapted and configured to be connected to corresponding electrical contacts (not shown) disposed on a front face of the socket body 17, so as to deliver energizing current from a power supply to the light source 18 through the contacts when the light source 18 is mounted and the energizing current is being delivered to the contacts on the socket body 17. In other embodiments, a light source (or part of a light source, such as a housing or diffuser) can be “connected” to the socket body 17 by being integrally formed therewith in one piece. Finally, “connected to” will be understood to include being connected indirectly, such as by an intermediate structure or intermediate group of interconnected structures, to which structure or group of structures both the light source and the socket body 17 are each connected directly.

Preferably, the light source 18 is connected so as to be positioned to illuminate a space in front of (distal of) the socket 16 when energized. Thus, light from the energized light source 18 can help a user holding the wrench 10 to see a fastener in front of the socket 16, such as a threaded nut or the threaded bolt B as depicted in FIG. 1, and to align the socket 16 to the fastener. More particularly, a light source connected to a light socket body according to embodiments is positioned so that the light socket body does not obstruct light directed from the light source the space distally in front of the light socket body, or at least so as to limit the degree of such obstruction. For example, if the light source is connected to an outer periphery of the light socket body (not shown) instead of its distal end face, the light source can extend distally to meet a distal end plane of the socket body and or radially outwardly so as to “see around” a distal end perimeter of the socket body to points distally in front of it, or in more technical terms, at least one light-emitting point on the light source is disposed radially outwardly of any portion of the socket body that extends distally beyond the light source, so that at least one straight line path extends from the light-emitting point to a space in front of the socket body without impinging or intersecting the socket body.

The light source 18 is depicted as a ring-shaped light diffuser 18, which covers and is illuminated by light-emitting componentry (not shown) such as an LED or a plurality of LEDs. Such light-emitting componentry can, for example, be disposed on the distal/front face of the socket body 17, circumferentially distributed about the X-axis, so that light emitted by the light emitting componentry passes through the light diffuser 18 and is emitted therefrom generally uniformly over an exposed light emitting surface area of the diffuser 18 (“generally uniformly” will be understood to mean more uniformly than the light that would pass through the same area from the light-emitting componentry not covered by a diffuser, and typically significantly more uniformly, with minimal or no perceptible variation in light intensity being by a person of ordinary, unaided vision). The diffuser 18 is shown as extending around an entire drive socket perimeter 19 of the socket body 17. In various other embodiments (not shown), other shapes of a light source than a closed ring are possible, such as a “point” source (that is, a source having an area spanned by a relatively small circumferential arc of the distal end face of the socket body 17, such as a ten-degree, five-degree or even smaller arc) or plurality of point sources (such as three point sources at points spaced one-hundred twenty degrees apart about the drive axis X) distributed about the drive socket perimeter 19, or an arcuate segment or plurality of intermittent arcuate segments extending peripherally around the drive socket perimeter 19 of the socket body 17. Other variations in the arrangement of a light source relative to a socket body are also possible within the scope of this disclosure, such as the light source being recessed into a distal end face of a socket body (not shown). In such embodiments, the light source can be recessed in such a manner that the socket body extends distally beyond the light source, so as to isolate the light source from distal end impacts of the socket body against broad, flat surfaces.

Optionally, the socket 16 further includes disposed around its periphery a protective sheath 20, illustrated as separately exploded from the socket body 17 in FIG. 1 and shown in more detail in FIG. 6, to protect its electrical components. The sheath 20 is generally in the form of a tube with a bore 21 extending axially therethrough. In case the light source 18 has a larger radius than the socket body 17, the sheath 20 can also have a countersunk annular cavity 23 formed at one end to accommodate an overhanging outer portion of the light source 18. The sheath 20 can be formed of a suitable shock absorbing and durable protective material, such a molded hard plastic or elastomer/rubber, and be affixed to the socket body 17 in a suitable manner, such as by a mechanical interference fit, by overmolding, or by the application of a suitable adhesive material (not shown).

The ratchet drive member 14 comprises a drive gear 22 and a socket drive 24 (typically a square drive as shown), the drive gear 22 including a set of peripheral drive teeth 26 that engage at least one ratchet pawl 28 in a head recess 30 of the rachet body 12 so as to force the drive gear 22 to rotate together with the head recess 30 about a drive gear axis X in a rotational drive direction, while permitting the drive gear 22 to rotate freely relative to the head recess 30 about the ratchet drive axis X in a rotational direction opposite the drive direction.

Merely for ease of illustration, the drive gear 22 and pawl 28 are shown as being operative to enable the wrench 10 to drive a fastener only in a clockwise (typically tightening) direction. It will be readily understood that the circuitry elements to be described herein can be analogously incorporated into a bidirectional-drive wrench without any added difficulty owing to differences in a bidirectional drive gear and pawl system, in which, for example, a drive gear may further include an axially offset second row of drive teeth (not shown) that are inclined in an opposite circumferential direction to a first row, and a ratchet body head recess may further include an axially offset second ratchet drive pawl (not shown) that is inclined in an opposite direction to a first drive pawl, the two drive pawls being selectively engageable and disengageable to set a loosening or tightening wrench drive direction. Likewise, although only one size of socket 16 is illustrated, the socket 16 is contemplated, in embodiments according to this disclosure, as being one of a provided set (not shown) of lighted sockets of different sizes that are operative, respectively, to drive corresponding fasteners of different sizes.

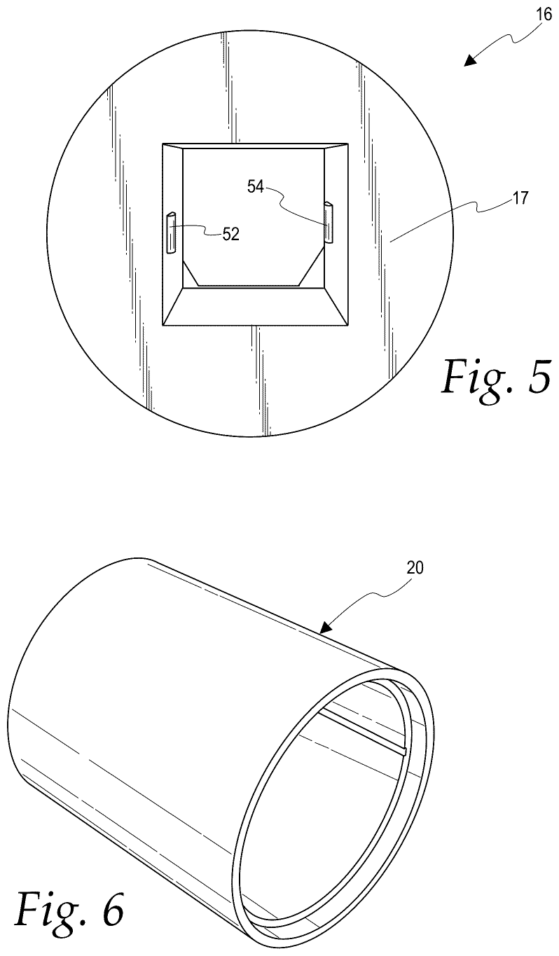

The wrench 10 further comprises an electrical circuit 29 which will now be described with reference to FIGS. 1, 2A, 2B, and 3-5. Turning to FIG. 1, the ratchet body 12 comprises a handle region 31 extending to its lower end and a power supply compartment 32 located in the handle region 31. The power supply compartment 32 houses a power supply 34 as illustrated schematically in FIG. 1. In various embodiments, the power supply 34 comprises one or more standard removable batteries, such as AA or AAA disposable alkaline or lithium disposable batteries or rechargeable nickel metal-hydride or lithium (e.g., 18650) batteries; a plug-in rechargeable battery, such as a lithium battery, or other suitable power source for the light source 18. In the case of a plug-in rechargeable battery, the ratchet body 12 can comprise a charging port 36, such as a USB C or similar charging port, which is connected to the power supply 34 so as to be operative to deliver charging current from a plugged-in charging cable (not shown) to the power supply 34.

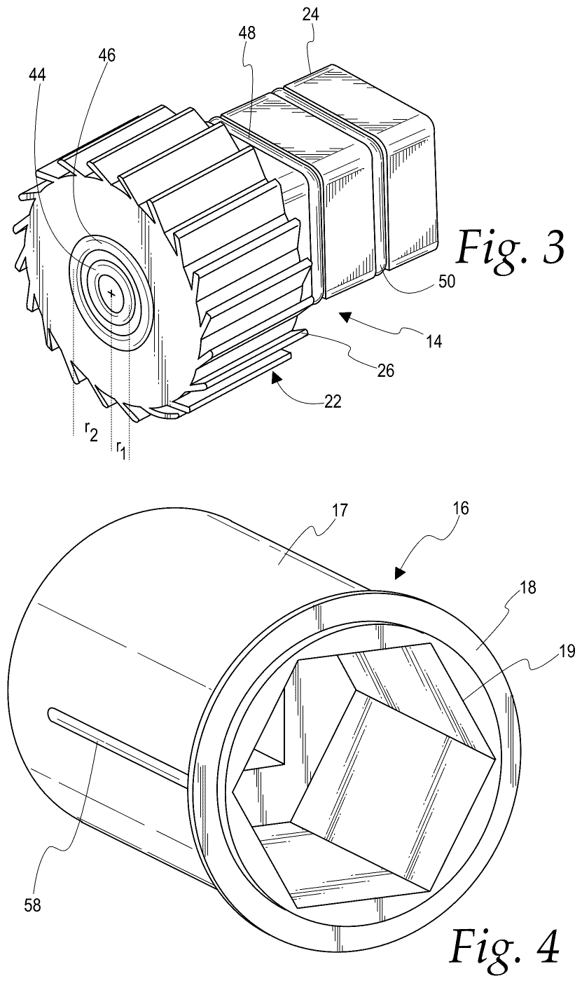

The circuit 29 further comprises ratchet body wiring 38 retained housed in the ratchet body 12; positive and negative ratchet body contacts 40, 42 retained by the ratchet body 12 and disposed in the head recess 30, the ratchet body contacts 40, 42 being connected to the wiring 38; positive and negative proximal drive member contacts 44, 46 (shown in FIG. 3) carried by the ratchet drive member 14, the proximal drive member contacts 44, 46 being in contact with the ratchet body contacts 40, 42, respectively; positive and negative distal drive member contacts 48, 50 carried by the ratchet drive member 14, the distal drive member contacts 48, 50 being connected to the proximal drive member contacts 44, 46, respectively, via internal wiring or equivalent conductive material (not shown); positive and negative socket body contacts 52, 54 carried by the socket body 17, the socket body contacts 52, 54 being in contact with the drive member contacts 48, 50, respectively; and positive and negative light source leads 56, 58 carried by the socket body 17, the light source leads 56, 58 being connected to the socket body contacts 52, 54, respectively. In turn, the light source leads 56, 58 are connected to the light source 18 so as to conduct electrical current through the light source 18 when the socket 16 is connected to the socket drive 24 and the circuit 29 is energized.

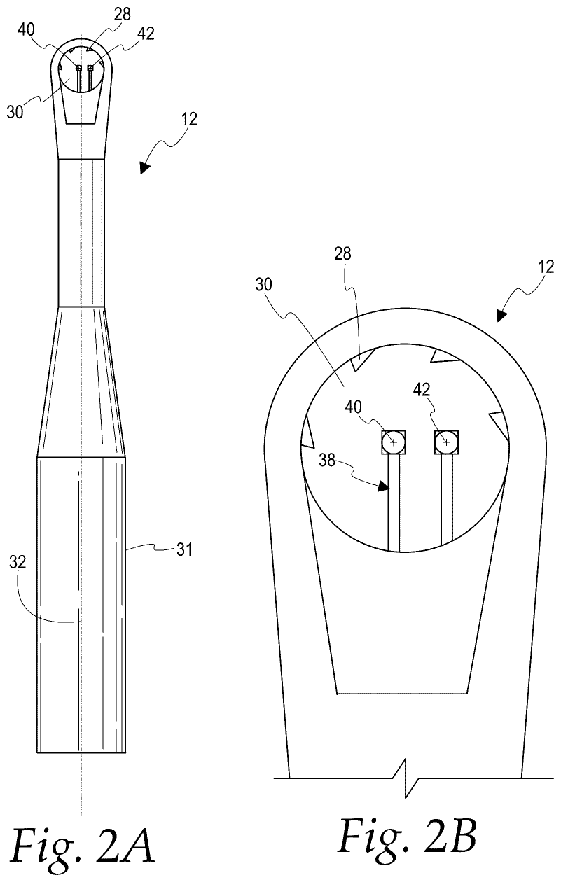

With reference to FIGS. 1, 2A, 2B, the positive and negative ratchet body contacts 40, 42 are spaced in opposite directions from the drive gear axis X at different radial distances r₁, r₂, respectively. (It will be noted that the radial offsets are depicted schematically as being vertical in FIG. 1 for ease of illustration in a side elevation view; however, the leads 40, 42 are physically offset from the axis X in opposite horizontal directions, as shown in FIGS. 2A, 2B, while in various other embodiments they can be offset in opposite radial directions at any rotational angle about the axis X.) The corresponding positive and negative drive member proximal end contacts 44, 46 are annular contacts of radius r₁, r₂, respectively, so that electrically conductive contact between the positive contact pair 40, 44 and between the negative contact pair 42, 46 is maintained as the drive gear 22 rotates in the head recess 30. The ratchet body contacts 40, 42 can be simple wire leads or, for example, can comprise rearwardly deflectable and forwardly spring-biased spring contacts, such as contact components that are commonly referred to as “pogo pins.”

In turn, as best seen in FIG. 3, the distal drive member contacts 48, 50 are provided in the form of square rings/annuli that surround the periphery of the socket drive 24. The distal drive member contacts 48, 50 are disposed at different longitudinal positions so that, when the socket drive 24 is fully inserted into said end, they contact the respective socket body contacts 52, 54, which are likewise longitudinally offset from each other. While each socket body contact 52, 54 is confined to an opposite interior peripheral sidewall of a proximal square-drive end of the socket body 17, the square peripheral ring shapes of the distal drive member contacts 48, 50 ensure that they will contact the respective socket body contacts 52, 54 in any of the four possible rotational orientations of the socket drive 24 for insertion into the proximal square-drive end of the socket body 17. In addition, the socket body contacts 52, 54 can be pogo pins that are spring-biased inwardly, to provide continuous electrical contact as well as to provide a detent connection with the distal drive member contacts 48, 50, and/or to operate as frictional gripping members, to retain the socket drive 24 in the socket body 17. To facilitate such a detent connection, the distal drive member contacts 48, 50 can be recessed slightly below flush with the outer perimeter of the socket drive 24, as shown in FIG. 3. This arrangement can be reversed in other embodiments, in which a pair of distal drive member contacts can be pogo pins confined to opposite exterior peripheral sides of a socket drive, while a corresponding pair of interior socket body contacts can be square rings surrounding the entire perimeter of the proximal socket-end interior sidewall at offset longitudinal positions, to ensure their alignment with the corresponding distal drive member contacts in any insertion orientation. Still more particularly, the socket body contacts 52, 54 are electrically insulated from the socket body 17

In view of the foregoing, it will be appreciated that when the ratchet drive member 14 is assembled to the ratchet body 12, and the socket 16 is attached to the socket drive 24, the circuit 29 can be completed so as to connect the power supply 34 to the light source 18. Thus, in embodiments (not shown), a switch component can be omitted from the circuit 29, resulting in the light source 18 always being on when the socket 16 is attached to the socket drive 24.

However, in the illustrated embodiment, the circuit 29 includes a switch 60, and when the socket drive 24 is fully inserted into the socket 16, the circuit 29 is operative to energize the light source 18 only when the switch 60 is closed and to de-energize the light source 18 when the switch 60 is opened. In embodiments, the switch 60 can be actuated manually by activating a switch actuator 61 (such as a hard button) disposed on the ratchet body 12. The switch actuator 61 can be operative to toggle the switch 60 between open and closed states on each activation. In other embodiments, the switch actuator 61 can be movable to and from an on position, in which the switch 60 is closed, and an off position, in which the switch 60 is opened. In still other embodiments, the switch 60 can have more than two states. In such embodiments with a discrete number of switch states, the switch actuator 61 can be a button operative to toggle the switch 60 through each of its states in a particular repeating sequence, or a dial or sliding switch with a plurality of detent-locked positions. Alternatively the switch 60 can be a dimmer switch with an off state in which the switch 60 is open and a continuous range of on states to supply a variable energizing current to the light source 18, and the switch actuator 61 can be any suitable type of dimmer switch actuator, for example, a button that operates to toggle the switch 60 on and off with a short press and to vary intensity with a long press, a dial, or a slider.

Alternatively, or in addition, the switch 60 can automatically be opened and/or closed upon the occurrence of triggering events. More particularly, the wrench 10 can include an electronic controller 63 operatively connected to the switch 60, the controller 63 being connected to the power supply 34 so as to be energized at all times and being configured (for example, hardwired or programmed) to open and/or close the switch 60 when it detects or receives a signal indicating the occurrence of a triggering event.

For example, in embodiments, the controller 63 can be configured to close the switch 60 in response to the socket 16 being disconnected from the socket drive 24, so that the circuit 29 is immediately energized to turn on the light source 18 when the socket 16 is reconnected. The controller 63 is further configured to start a timer when it detects that the circuit 29 is energized, to keep the switch 60 closed for a predetermined time after the socket 16 is attached, and to open the switch 60 when the timer expires. For example, the controller 63 can comprise a clock or be operatively connected to a separate clock (not shown). Thus, the controller 63 can open the switch 60 in response to a signal from the clock indicating that the predetermined time has elapsed from the timer. This limits the amount of energy that can be drained from the power supply 34 by the light source 18 remaining on when a user unintentionally leaves the socket 16 connected after using the wrench 10. On the other hand, if the timer expires and causes the light source 18 to turn off while the wrench 10 is in use, a user can turn the light source 18 back on if desired, by disconnecting the socket 16 to close the switch 60 and reconnecting the socket 16, thereby energizing the circuit 29 and causing the controller 63 to restart the timer.

In other embodiments, the controller 63 can be hardwired or programmed to open the switch 60 only after a predetermined time period of non-use, such as by detecting no displacement of the drive gear 22 for the predetermined time period. For example, the controller 63 can be operatively connected to a ratchet pawl 28 so as to detect that the drive gear 22 has been displaced (and restart a non-use timer) whenever the ratchet pawl 28 is depressed by one of the gear teeth 26 passing over it, and the controller can be configured to open the switch 60 when the non-use timer expires without the controller detecting that the ratchet pawl 28 has been depressed. Optionally, the controller can also be configured to close the switch 60 when displacement of the drive gear 22 is detected while the switch 60 is open. Alternatively or additionally, a user can turn the light source 18 on by activating the switch actuator 61, and/or the controller can be configured to close the switch 60 in response to the socket 16 being disconnected as in the previously described embodiments, such that the user can turn the light source 18 on by disconnecting and reconnecting the socket 16.

In still other embodiments, the circuit 29 further comprises a motion sensor 62 as shown in FIG. 1, which is operatively connected to the switch 60 and to a clock (not shown). The motion sensor 62 can be operative to cause the switch 60 to open and de-energize the light source 18 when it detects no movement of the socket wrench 10, indicating non-use of the socket wrench 10, during a predetermined time period with the switch 60 closed. On the other hand, it will be appreciated that while non-movement of the socket wrench 10 is a reliable indicator that it is not being used, movement does not necessarily indicate that it is. For example, the socket wrench 10 will move when simply being carried from place to place. Thus, it is likely to be desirable for the controller to use input from the motion sensor 62 only to turn the light source 18 off, but not on. Instead, a user can turn the light source 18 on by activating the switch actuator 61, and/or the controller can be configured to close the switch 60 automatically in response to the socket 16 being disconnected as described above, such that the user can turn the light source 18 on by disconnecting and reconnecting the socket 16. In any of the preceding embodiments in which the switch 60 is triggered to be opened by a timer, the switch 60 can also be configured to open in response to an activation of the switch actuator 61. Thus, a user can have the option to use the switch actuator 61 to power off the light source 18 manually, rather than waiting for the timer to expire.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A lighted socket wrench comprising:
a ratchet body;
a power supply, the power supply being housed in the ratchet body;
a ratchet drive member, the ratchet drive member being rotatably connected to the ratchet body for rotation about a drive axis;
a lighted socket, the lighted socket comprising a socket body and a light source connected to the socket body, the light source being adapted to be energized by electric current, and when so energized, to emit light, the lighted socket being adapted to be removably connected to the ratchet drive member;
a power circuit, the power circuit being adapted and configured to deliver electric current from the power supply to the light source to energize the light source when the lighted socket is connected to the ratchet drive member.

2. The lighted socket wrench of claim 1 wherein the power circuit further comprises a switch, the switch being operative to change from an open state to at least one closed state, the power circuit being operative to deliver electric current to the light source only when the switch is not in the open state.

3. The lighted socket wrench of claim 2 further comprising a motion sensor, the motion sensor being operatively connected to the switch, the motion sensor being operative to detect movement of the lighted socket wrench, to cause a timer to be restarted each time movement is detected, the timer being set to expire at a predetermined time after being restarted, and to cause the switch to open when the timer expires.

4. The lighted socket wrench of claim 2 further comprising an electronic controller, the electronic controller being operatively connected to the switch, the electronic controller being adapted and configured to open the switch in response to a switch opening trigger event and to close the switch in response to a switch closing trigger event.

5. The lighted socket wrench of claim 4 wherein the switch closing trigger event comprises the lighted socket being disconnected from the ratchet drive member, the switch opening trigger event comprising the lighted socket being continuously connected to the ratchet drive member for a predetermined time period.

6. The lighted socket wrench of claim 1, wherein the light source is disposed proximate to a front end of the socket body such that, when the light source emits light, at least a portion of the emitted light is directed to a space in front of the socket without impinging the socket body.

7. The lighted socket wrench of claim 1 wherein the power circuit further comprises:
ratchet body wiring housed in the ratchet body;
positive and negative ratchet body contacts retained by the ratchet body, the ratchet body contacts being conductively connected to the ratchet body wiring;
positive and negative proximal drive member contacts, the proximal drive member contacts being carried by the ratchet drive member, the positive and negative proximal drive member contacts being in contact with the positive and negative ratchet body contacts, respectively;
positive and negative distal drive member contacts carried by the ratchet drive member, the positive and negative distal drive member contacts being conductively connected to the positive and negative proximal drive member contacts, respectively;
positive and negative socket body contacts carried by the socket body, the positive and negative socket body contacts being in contact with the positive and negative drive member contacts, respectively;
positive and negative light source leads carried by the socket body, the positive and negative light source leads being conductively connected to the positive and negative socket body contacts, respectively, and to the light source.

8. The lighted socket wrench of claim 7, the distal drive member contacts comprising annular contacts disposed at an outer periphery of the ratchet drive member and the socket body contacts comprising pins disposed on an inner periphery of the socket body, the pins being adapted and configured to be biased radially inwardly against the annular contacts when the socket body is connected to the ratchet drive member.

9. The lighted socket wrench of claim 7 wherein the light source leads are electrically insulated from the socket body.

10. The lighted socket wrench of claim 1 wherein the power supply is removably housed in the ratchet body.

11. The lighted socket wrench of claim 10 wherein the removable power supply is a rechargeable lithium cell.
